(19) United States
(12) Patent Application Publication
(10) Pub. No.: US 2009/0084199 A1
(43) Pub. Date: Apr. 2, 2009

(54) Quick-change sorbent trap module and method

(76) Inventors: James E. Wright, Pittsburgh, PA (US); Daniel J. Rybarski, Algonquin, IL (US)

Correspondence Address: Olson & Cepuritis, LTD., 20 NORTH WACKER DRIVE, 36TH FLOOR, CHICAGO, IL, 60606, US

(21) Appl. No.: 11/904,989

(22) Filed: Sep. 28, 2007

(51) Int. Cl. G01N 1/26; G01N 1/22

(52) U.S. Cl. 73/863.82; 73/863.11

(57) ABSTRACT

A quick-change probe, cartridge and method of their use are provided for obtaining a sample from a gas stream. A cartridge containing a sample insert is removably inserted within a hollow channel of an outer housing. The sample insert, removably received within the cartridge, has a first end with a gas inlet and a second end for connection to downstream processing equipment. A externally controlled or self-regulating heating cable, thermal sensor and a thermal insulator are disposed within the probe. The sample insert may be withdrawn from the cartridge, or the cartridge with the sample insert included, may be withdrawn from the probe.

### FIELD OF THE INVENTION

The present invention relates to the testing of atmospheric emissions and, in particular, to such testing involving the use of samples withdrawn from a flue gas stream or other atmospheric discharge.

### BACKGROUND OF THE INVENTION

Care must be taken in complying with approved air quality regulations. Compliance may be audited by a site visit for testing purposes, or a continuous monitoring program may be required. In either event, testing can require a substantial investment in capital and manhours. However, a duty is also owed to shareholders, business owners and investors to conduct business operations in as financially responsible a manner as possible, including effective cost containments wherever possible, consistent with environmental and other regulations.

Accordingly, responsible business owners, consultants and vendors to operators of combustion devices and other emission sources are interested in refining mandated environmental testing from an economic as well as a technical compliance standpoint. Advantages to such refinements are even greater where the monitoring is required to be conducted on a continuous basis, due to the number of testing operations involved and their required investment in capital and operating expense. Obviously, these concerns extend to testing of all kinds, regardless of the particular substance to which the testing is directed.

As indicated, owners and operators of certain combustion devices are required to comply with a variety of environmental regulations pertaining to the maximum allowable emissions of a particular substance. One example of such regulations involves the concentration of a substance suspended in a waste gas, such as the flue gas of a combustion device, that discharges a waste gas stream into the atmosphere. In addition to specifying maximum allowable amounts or concentrations, environmental regulations at times specify how a waste gas stream is to be tested in order to determine regulatory compliance. Taking into account the different technologies and characteristics of substances involved, different testing techniques are often required for different types of substances, and additionally for different timing of such testing. For example, testing can be periodic or continuous.

One example of continuous emission monitoring regulations is found in part 75 of Title 40 of the Code of Federal Regulations, which relates to the protection of the environment by way of continuous emission monitoring. Subpart I of these regulations is concerned with the continuous emission monitoring of mercury mass emissions of certain coal-fired units. Included in the regulations is a requirement as to how certain aspects of the continuous emission monitoring are to be performed.

### SUMMARY OF THE INVENTION

The present invention provides a novel and improved method and apparatus for withdrawing carefully controlled samples from an active flue gas source, allowing easy withdrawal of the sample material, while leaving associated equipment, such as vacuum pumps and line heaters, undisturbed. The present invention minimizes the disadvantages associated with prior art methods and apparatus and provides advantages in the mode of operation and use of the testing method, as well as devices and materials related thereto.

One embodiment of such testing equipment comprises a quick-change probe, cartridge and sample insert for obtaining a sample from a gas stream. A cartridge containing the sample insert is removably inserted within a hollow channel of an outer probe housing. The sample insert, removably received within the cartridge, has a first end with a gas inlet and a second end for connection to downstream processing equipment. The probe includes a externally controlled or self-regulating heating cable, thermal sensor and a thermal insulator that are disposed within the probe housing. The sample insert may be withdrawn from the cartridge, or the cartridge with the sample insert included, may be withdrawn from the probe. If desired, the probe may accommodate multiple cartridges having their own respective sample inserts, arranged, for example, for simultaneous parallel sampling operations.

In another embodiment, a cartridge is provided for removable positioning within a probe to obtain a sample from a gas stream. The cartridge includes an outer shell having a first end for a gas inlet and a second end. At least one hollow channel is defined within the shell, and a sample insert is removably received within the hollow channel. The sample insert has a first end with a gas inlet and a second end for connection to downstream processing equipment. The first end of the shell has a releasable engagement for releasably engaging the probe, and at least one gas seal is provided between the sample insert and the shell.

In one embodiment, a method of obtaining a sample from a gas stream includes the steps of providing an outer housing having a first end for a gas inlet and a second end, and at least one hollow channel. A shell with a first end for a gas inlet and a second end is also provided. The method further includes the step of removably inserting the shell within the hollow channel, with the first ends of the housing and the shell adjacent one another, and with the second ends of the housing and the shell adjacent one another. A sample insert is provided with a first end having a gas inlet and a second end having gas outlet. The method also includes removably inserting the sample insert within the shell with the first ends of the housing, the shell and the sample insert adjacent one another, and with the second ends of the housing, the shell and the sample insert adjacent one another and removably securing at least one of the shell and sample insert to the housing. Either the sample insert may be withdrawn from the cartridge, or the cartridge with the sample insert included may be withdrawn from the probe.

### BRIEF DESCRIPTION OF THE DRAWINGS

In the drawings:

FIG. 1 is a schematic representation of a probe according to principles of the present invention;

FIG. 2 is an end view thereof;

FIG. 3 is a side elevational view thereof;

FIG. 4 is a side elevational view thereof, shown partly broken away;

FIG. 5a is an exploded perspective view thereof,

FIG. 5b is a perspective view of a cartridge component thereof;

FIG. 6 is a schematic diagram of a testing assembly employing the present invention;

FIG. 7 is a cross-sectional view taken along the line 7-7 of FIG. 6;

FIG. 8 is a cross-sectional view taken along the line 8-8 of FIG. 3; and

FIG. 9 is a schematic diagram of a testing system.

### DESCRIPTION OF THE PREFERRED EMBODIMENTS

The invention disclosed herein is, of course, susceptible of embodiment in many forms. Shown in the drawings, and described herein in detail are preferred embodiments of the invention. It is understood, however, that the present disclosure is an exemplification of the principles of the invention and does not limit the invention to the illustrated embodiments.

For ease of description, a system for testing a gas stream such as a combustion flue gas stream embodying the present invention is described herein in its usual assembled position as shown in the accompanying drawings and terms such as upstream, downstream, inner, outer, upper, lower, horizontal, longitudinal, etc., may be used herein with reference to this usual position. However, the system may be manufactured, transported, sold or used in orientations other than that described and shown herein.

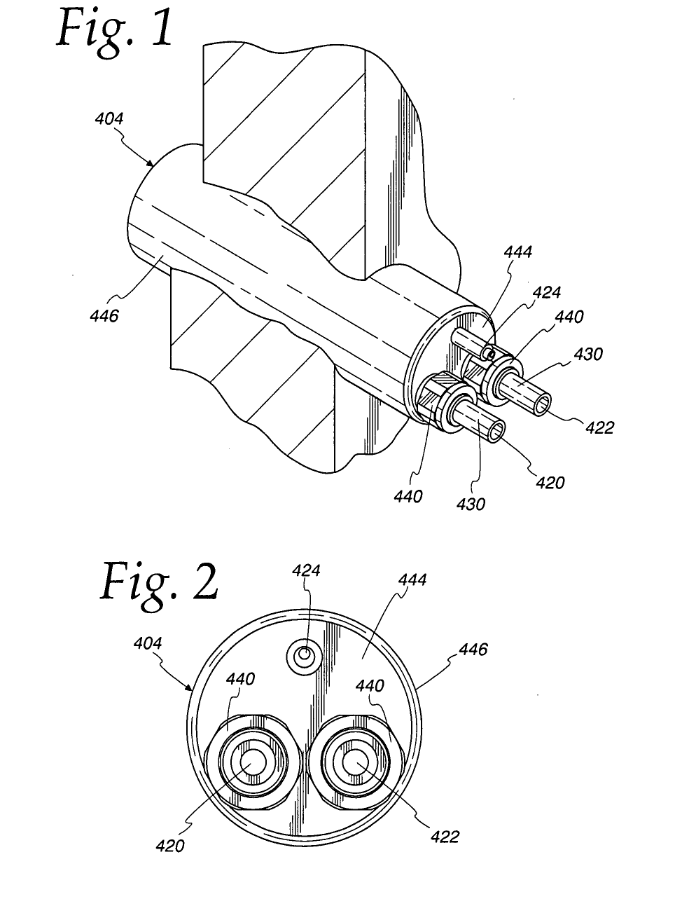

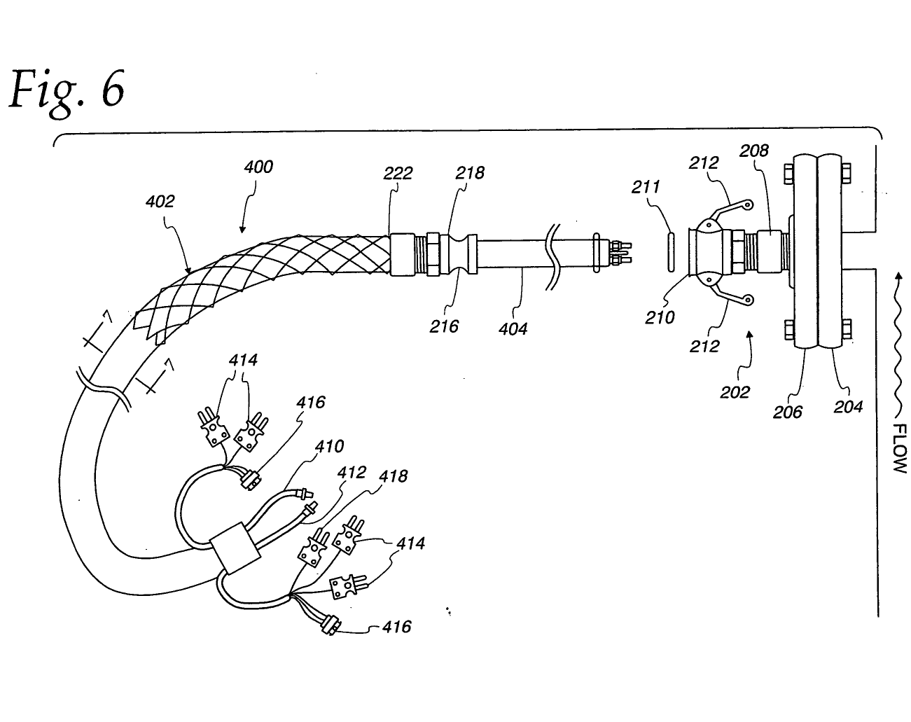

Referring now to the drawings, and initially to FIG. 1, a probe 404 is provided as part of a test assembly 400 shown in FIG. 6. In FIG. 1, probe 404 is shown in schematic form, associated with a containment wall of a gas stream, such as a wall of a smoke stack. Referring now to FIG. 6, a testing assembly is generally indicated at 400. Included is a flexible sample line 402 and a generic probe 404. If desired, probe 404 and sample line 402 could be made to carry only a single sampling channel. However, in a preferred embodiment, sample line 402 and probe 404 have the capacity to carry multiple separate, independent sampling channels, and are thus referred to herein as a multi-channel sample line and a multi-channel probe, respectively. As can be seen in FIG. 6, the sample line 402 and probe 404 are joined, preferably permanently joined, so as to form a single unitary testing assembly.

Probe 404 and sample line 402 preferably have multiple separate and independent gas sampling channels. In the preferred embodiment, the gas sampling channels include tubing of flexible, non-reactive material such as TEFLON or other engineered fluoropolymeric material. The flexible lines are indicated in FIG. 6 at 410, 412. Also included are connectors for a variety of auxiliary equipment such as sensor and heaters. Included are connectors 414, 416 associated with each flexible line and a connector 418 associated with instrumentation separate from the flexible lines.

Probe 404 can have either single or multiple channel capability. As mentioned, in a preferred embodiment, probe 404 has multi-channel gas sampling capability and includes a pair of gas sampling channels. Referring to FIG. 6, the gas sampling channels have inputs 420, 422. A thermocouple 424 is also located adjacent gas inputs 420, 422. In the preferred embodiment, probe 404 is designed to have a specialized gas sampling capability, to withdraw gas samples using absorbent material. In a preferred embodiment, probe 404 utilizes sorbent trap technology. If desired, other known sample collection technologies such as filtration or condensation can be used in place of the sorbent trap insert.

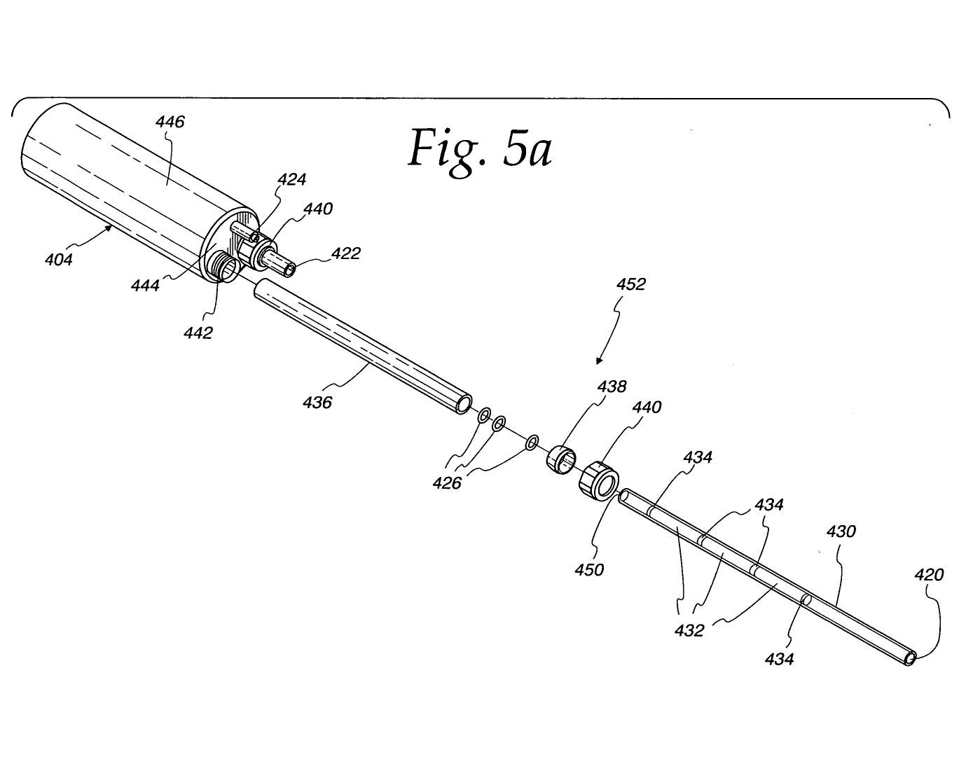

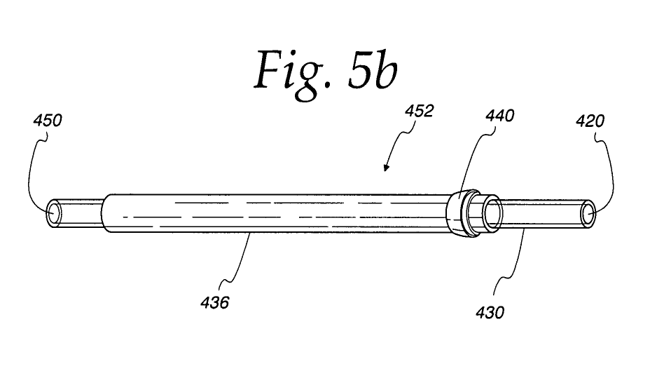

Referring briefly to FIG. 5a, included in probe 404 is a sorbent trap insert including sections 432 of sorbent trap material. Although not required in all instances, the sorbent trap insert 430 is removably received within an outer cartridge shell 436 of rugged stainless steel construction. A ferrule or frustoconical collar 438 is attached, preferably by welding or brazing, to the inlet end of cartridge shell 436 and a nut or compression fitting 440 threadingly engages a threaded nipple 442 which is fitted to an end cap 444 of a rugged stainless steel housing 446 of probe 404 that receives the cartridge. The compression fitting 440 can provide a number of advantages. First, the fitting secures the cartridge and its sorbent trap insert against vibration, either induced directly through the mounting of the probe to a facility structure, or through turbulence across the probe free end, which is disposed in the flue gas stream. If desired, the compression fitting 440 can slightly compress ferrule 438 so that it securely engages the cartridge insert. As a further possible advantage, the compression fitting can effectively seal the cartridge shell to the probe housing, preventing incoming leakage under pressure of the flue gas stream, and/or under vacuum applied to the cartridge, its insert or the probe assembly.

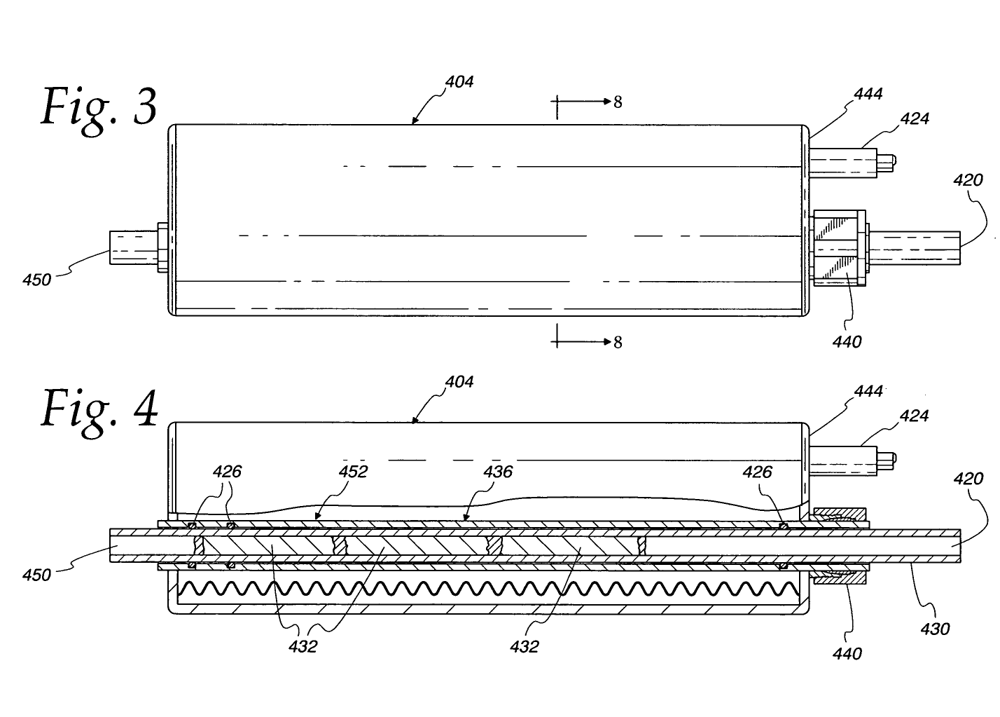

In a preferred embodiment, the compression fitting 440 can be removed for ready withdrawal of a sample cartridge formed by the combination of sorbent trap insert 430 and outer shell 436. The sorbent trap insert 430 may be easily withdrawn from shell 436 with the shell 436 either removed from housing 446 or left in place as shown, for example, in the adjacent gas sampling channel having input 422. However, virtually any sample probe arrangement can be utilized with the present invention, and removable insert and/or removable cartridge assemblies may not be required in all instances. Referring to FIGS. 3 and 4, the downstream ends 450 of the sorbent trap inserts 430 are coupled to flexible lines 410, 412 (see FIG. 6) to form a continuous gas sampling passageway. As will be seen herein, auxiliary equipment such as thermocouples and heaters are combined with the gas passageways to form a pair of gas sampling channels.

Referring now to FIG. 7, a cross-sectional view of sample line 402 is shown. Included in the sample line 402 are two gas sampling channels generally indicated at 454, 456. Included in each channel are flexible hollow lines 410, 412 which, as mentioned above, are preferably made of TEFLON material. Surrounding the flexible lines 410, 412 is an outer covering 462 of thermal barrier material such as fiberglass cloth which is coated, wrapped or otherwise disposed about each flexible line. As indicated in FIG. 7, the channels 454, 456 are spaced apart and disposed within a rugged outer weatherproof jacket 466 of polyurethane material. The outer jacket 466 is preferably formed with a shrink-wrap process. The interior of sample line 402 is filled with a thermal insulator material such as glass fiber insulation and, most preferably, non-hygroscopic glass fiber insulation material indicated at 468.

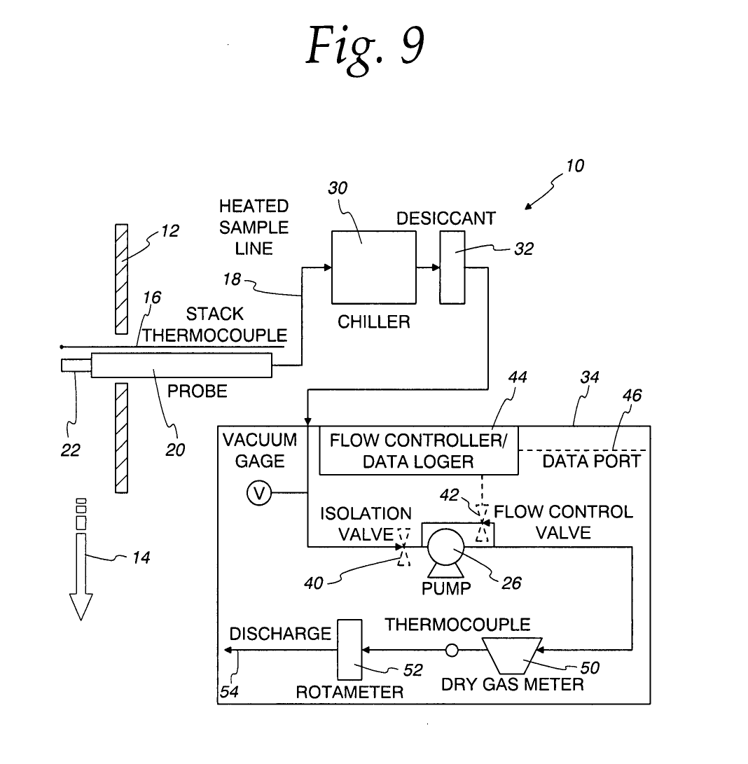

Also included in each gas channel is a externally controlled or self-regulating heater, preferably in the form of electrical cables schematically indicated at 472. Preferably, each flexible line is wrapped with two independent externally controlled or self-regulating electric resistance cable heaters. The length of the first heater cable is equal to the length of the flexible line that is inserted into the process stream. The second heater cable is wrapped around the length of flexible line that remains outside of the process stream. As indicated in FIG. 7, the heater cables are encapsulated in insulation material 468. In the preferred embodiment, the two heaters for each gas channel provide an arrangement for maintaining two temperature zones. One zone is the section of the sample line that is covered by the probe sheath or outer probe housing 446. This section is exposed to the process gas and must maintain the proper sample gas temperature while being exposed to the temperature of the process gases. The second heated zone is the section of the flexible line that transports the extracted sample to downstream equipment such as a gas conditioning and pumping system of the type generally indicated in FIG. 9 to be discussed below. The second heated zone maintains the proper gas temperature while being exposed to ambient air temperature.

The section of the sample line 402 that is inserted into the process stream is wrapped with a high temperature protective jacket of silicone material. This section is placed inside the rigid stainless steel tube forming the outer housing 446, shown in FIG. 5a. As mentioned, the housing 446 at the free end of the probe is joined to an end wall 444, preferably by welding, brazing, or other metallurgical joinder. The portion of sample line 402 that remains outside of the process gas is wrapped with the weatherproof protective jacket 466.

In preferred embodiment, sample line 402 contains instrumentation for the operation of the testing assembly. Included are a number of thermocouples measuring different operating parameters. The thermocouples are accessed by connectors 414, 418 shown in FIG. 6. Referring again to FIG. 7, a line thermocouple 480 is employed to measure the internal temperature of sample line 402. As mentioned with reference to FIG. 1, a thermocouple 424 is provided for sensing the temperature of the process gas and is placed in-situ in the gas stream adjacent gas inlets 420, 422. The signal for this thermocouple is carried by electrical conductor 482 shown in FIG. 7. Connection with the thermocouple is made with connector 418 in FIG. 6. As mentioned, the sorbent trap inserts 430 are located in probe 404. Preferably, the temperature of the sorbent traps are monitored by their own respective thermocouples, with signals being transmitted through electrical conductors 486, 488 to a pair of connectors 414 as shown in FIG. 6.

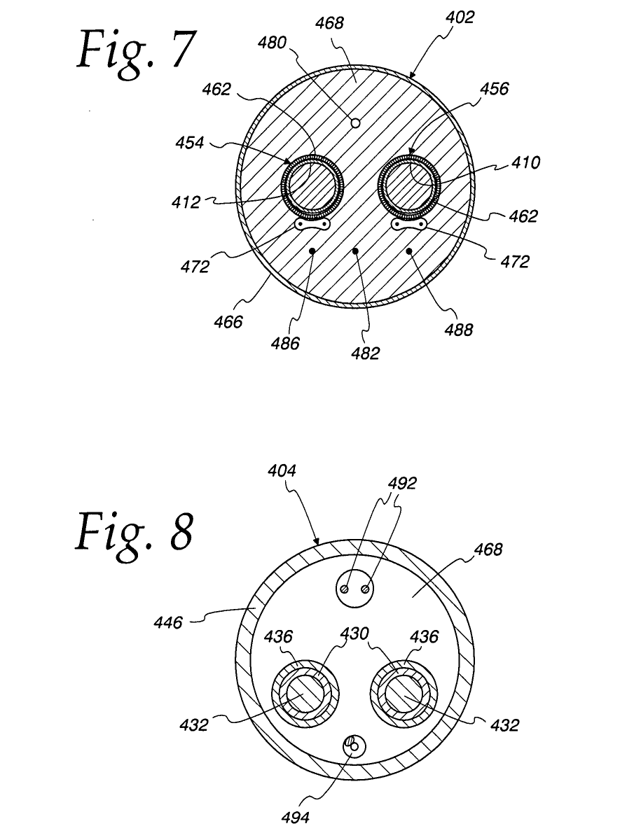

Referring now to FIG. 8, a section of probe 404 is shown schematically in cross-section. Included are the sorbent trap inserts 430, preferably in the form of hollow glass tubes receiving sections of sorbent trap material 432 separated from one another by separator sections 434 as shown for example in FIG. 5a. Referring again to FIG. 8, the outer shell 436 of the sorbent trap cartridge surrounds the sorbent trap inserts 430. Electrical conductors 492 for thermocouple 424 are located in the upper portion of FIG. 8 and electrical conductors 494 are provided for additional instrumentation. The interior of the probe is filled with thermal insulation which, as mentioned, preferably comprises non-hygroscopic glass fiber insulation. Shown in FIG. 8 is the outer jacket 466, which preferably is located immediately inside of the ruggedized, rigid, stainless steel housing 446.

Sorbent trap modules or probes according to principles of the present invention allow sorbent trap inserts to be quickly inserted and removed from the probe without the use of tools. The trap or insert is pushed by hand into a removable module inside the probe, preferably in the form of cartridge 452 shown for example in FIG. 5b. A leak-tight seal is made between the insert 430 and the shell 436 of cartridge 452 by a series of three o-rings 426 preferably contained within interior grooved rings formed inside of cartridge shell 436 in the manner indicated in FIG. 4. The probe 404 and cartridge 452 preferably include outer housings made of stainless steel or another type of corrosion-resistant ridged material. Preferably, the o-rings 426 are made of a pliable, chemically resistant and thermally stable polymer such as silicone or VITON. The cartridges 452 are held in place within the probe and sealed to the probe using a threaded compression fitting 442, ferrule 438 and nut 440.

Accordingly, the sorbent traps, i.e., sorbent trap inserts 430 can be inserted and removed without the need for tools such as wrenches or pliers. With the present invention, the sampling process is simplified and is made more time efficient. The sorbent trap module or cartridge 452 can be readily removed from probe 404 and replaced with a new one, as may be desired. The nut 440 used to hold the cartridge in place within probe 404 may be tightened and loosened with a wrench, but, according to a preferred embodiment, the cartridge 452 is not removed from the probe 404 except for periodic maintenance. In this regard, it is generally preferred in the present invention that three o-rings are provided to seal the sorbent trap insert 430 and to provide redundancy in case of failure of a particular o-ring. Further, as can be seen for example in FIG. 4, it is generally preferred that two o-rings be placed close to each other at the downstream end 450 of the sorbent trap insert and that a single o-ring be located at the forward or free end of probe 404, adjacent the gas inlet end 420 of the sorbent trap insert.

With reference to FIG. 6, the test assembly 400 conveniently provides a multichannel, redundant testing capability which is often a condition for a regulatory body to allow self-testing programs implemented by the facility operator, rather than a designee or member of the responsible agency. In order to provide maximum benefits to an operator, the testing assembly should be relatively lightweight and for the most part reusable from one testing operation to another. This is particularly important where continuous or quasi-continuous monitoring is required. Several times a day, during continuous operation of the facility, examples are withdrawn from the gas stream, an operation often repeated during the life of the facility, especially since many large scale facilities are seldom completely shut down.

As mentioned above, the probe 404 is preferably made rigid and with locating fitting 218 allows the accurate positioning of inlets for the gas sample channels within the gas stream flow to be tested. However, in light of the need for gas-tight seals to be continuously maintained during testing and the need for flexibility to allow the probe to be permanently joined to the sample line 402, it is important that the sample line be made relatively flexible, without compromising leak-free integrity of the test assembly. The preferred construction described above with reference to FIG. 7, for example, allows sample line 402 to meet these criteria while being relatively lightweight. The materials and dimensions of one example of a testing assembly have been given herein and afford a relatively lightweight construction.

With testing assemblies according to principles of the present invention, the exposed portions of the trap inserts, at the inlet to the gas channels, may be carefully controlled and protected by an operator from accidental contact and breakage, when contacting a nearby object. It should be remembered, in this regard, that testing facilities are not typically designed during construction of many existing facilities, but rather are added later, where space and other conditions allow. Further, testing operations are, in many instances, conducted, continuously, year-round. In cold weather when gloves and other protective apparel are required, the ability to control the free end of probe 404 and the exposed glass tubes projecting therefrom, becomes even more important. The flexible sample line 402 and the construction of the rigid probe 404, the precision positioning fitting 218, and the receptacle construction 202 all contribute to ensure that continuous testing programs and other testing programs can be successfully carried out, even during extreme atmospheric conditions.

The testing assembly according to the principles of the present invention provides a compact, relatively lightweight arrangement which aids in obtaining gas samples in difficult work areas of restricted accessibility such as may be provided about a smokestack of an operating combustion facility. For example, in one preferred embodiment according to the present invention, the outer housing 446 of probe 404 has an approximately 2.5 inch outer diameter and sample line 402 has an outer diameter of similar dimensions. The sorbent trap inserts 430 are made of hollow glass tubing having an outer diameter of about 0.39 inches and an inside diameter of approximately 0.32 inches. The walls of outer shell 436 of the cartridge preferably have a thickness of approximately 0.09 inches and a length of approximately 8.5 inches. The flexible lines 410, 412 preferably have an approximate nominal external diameter of about one quarter inch.

Turning again to FIG. 6, a fitting assembly generally indicated at 202 is provided for support and control of depth insertion of the probe in the process stream. Included in assembly 202 is a port 204 and flange 206. Connected to flange 206 is a pipe nipple 208 which preferably has a nominal internal diameter of about 2.5 inches. Also included is a quick lock fitting 210 with an internal bore of approximately 2.5 inches, dimensioned to receive probe 404. A pair of cam locks (not shown) protrude into the inner bore of fitting 210 and are operated by lever arms 212. The cam members seat against a grooved portion 216 of a fitting 218 mounted at one end of probe 404 and preferably rigidly connected thereto by welding, brazing or other form of metallurgical joinder. A flexible, high-temperature o-ring 211 (e.g., Viton) sits in a groove within the fitting 210 and seals against fitting 218 when the cam locks are engaged. Fitting 218 is in turn connected to sample line 402 and a strain relief system 222 is provided to transfer support load to assembly 202.

In operation, probe 404 is inserted into fitting 210 so as to project into the process flow in the manner indicated in FIG. 1. Preferably, fitting 218 provides an approximate insertion limit by engagement with fitting 210. The final insertion control is provided when the cam locks are operated by level arms 212 with the cam locks received in groove 216 to provide a final, rigidly secure and accurately positioned engagement of the probe with respect to the process stream.

Although a particular probe construction has been described above, the testing assembly according to principles of the present invention can readily employ probes of different constructions and operating principles. Further, those skilled in the art will readily appreciate that the sample line can be readily modified to accommodate different numbers of gas channels to be monitored. For example, a single channel can be readily provided as can a system having three or more gas channels.

Turning now to FIG. 9, a sorbent trap system is generally indicated at 10. Included is a duct wall 12 confining a gas stream which flows in the direction of arrow 14. An entrance 16 formed in duct wall 12 is provided for probe assembly 20. Probe 20 includes an absorbent trap 22 which is placed in the gas stream. A pump 26 draws flue gas through trap 22 and probe 20. That portion of the gas stream passing through trap 22 is drawn through a chiller 30 and desiccant unit 32 before entering subsystem 34 which includes pump 26. An isolation valve 40 and flow control valve 42 are provided along with a flow controller/data logger 44 which outputs data on port 46. Gas stream leaving pump 26 passes through dry gas meter 50 and a rotating meter device 52 before being discharged at 54.

As will be appreciated, the testing system and method according to principles of the present invention can be used with a wide variety of different types of gas streams for measuring or otherwise analyzing different types of gas stream components. Preferably, the system and method according to principles of the present invention are used with testing methods typically employed to measure or analyze trace quantities of gas steam components using various technologies such as absorbent traps. In one example, the present system and method allow for performance-based monitoring of vapor-phase mercury emissions in a combustion flue gas stream. The performance-based monitoring may, for example, be carried out according to standards set by the United States Environmental Protection Agency (USEPA) such as those specified in 40 CFR, part 75, Appendix K and part 72(which are incorporated herein by reference as if set out in their entirety). Further details concerning sorbent trap system 10 may be found in 40 CFR, Section 72.2.

Thus, although an example of the system and method according to principles of the present invention are explained with regard to the monitoring of mercury emissions, it will be readily appreciated by those skilled in the art that the present system and method can be used to test or analyze virtually any substance for which a sorbent trap system is employed. Title 40 of the Code of Federal Regulations, contains Subpart I directed to mercury mass emission provisions. Under Chapter or Subpart I of Title 40 of the Code of Federal Regulations an owner or operator of a combustion source may elect to use sorbent trap monitoring systems to continuously monitor mercury content of the flue gas stream using sorbent trap monitoring systems defined in Section 72.2 of the Chapter to quantify the mercury mass emissions. Each sorbent trap monitoring system employed therein must be provided with primary, backup and spiked sample sections.

The sorbent traps are employed in pairs, according to the provisions of Appendix K of 40 CFR 75. The sorbent traps are used in a continuous paired sampling using sorbent media placed directly in the gas stream, coupled with an integrated sample analysis. It is contemplated that such testing is continuously performed in an ongoing performance environment. Accordingly, the collection of samples is carried out on an “in-stack” basis with the samples being directly drawn from a flue gas stream of a combustion device. As indicated in FIG. 9, in the preferred embodiment, samples are obtained by drawing off a portion of the flue gas stream using a vacuum pump to ensure that the traps are exposed to a large volume of flue gas in a relatively short amount of time so as to make it more likely that measurable trace amounts of the analyte of interest (e.g. mercury) are accumulated in the sections of the sorbent traps. In the practical conditions of the preferred embodiment, it is important that iterations of the flue gas analysis be performed in a relatively short time frame. After each sample collection, the mass of mercury adsorbed in the sorbent trap is readily removed for remote determination according to procedures specified in the regulations.

As will be appreciated, the system and method according to principles of the present invention can be employed to satisfy the practical requirements of a wide range of analytical requirements. As mentioned in the preferred embodiment, an analyte of interest is mercury entrained in a flue gas stream of a combustion source. According to these particular requirements, analysis is carried out using paired sorbent traps, each having a primary and a backup section, in addition to a section containing a spiked sample serving as an analytical standard.

The foregoing description and the accompanying drawings are illustrative of the present invention. Still other variations and arrangements are possible without the parting from the spirit and scope of this invention. For example, although the system and method according to the principles of the present invention have been explained above with regard to the analysis of combustion flue gas, it will be readily appreciated that the present system and method can be employed with other types of gases, both static and dynamic. That is, the present system and method can be employed with a gaseous flow which does not have a defined flow stream. Further, although a vacuum pump has been disclosed as a preferred mode of carrying out operations using the system of FIG. 9, virtually any technique that exposes the trap sections to the gaseous medium are contemplated by the present invention. For example, although a vacuum pump has been disclosed, a pressure pump arrangement could be employed in its place. Further, the probe, the cartridge and the traps (or other collection devices) can be moved through a relatively static body of gas, in place of the use of vacuum or pressure pumps which cause a gas flow to be passed across the trap sections.

As a further variation, other types of pre-sample spiking can be used. For example, the use of sorbent traps has been described above in the preferred embodiment. It will be appreciated by those skilled in the art that other types of “traps” can be employed, such as reactive traps in which a chemical bond is formed with the analyte. Further, condensation may be employed with what may be termed condenser “traps” so as to capture the analyte of interest for subsequent analysis.

As mentioned above, the system and method according to principles of the present invention can be employed with virtually any analyte of interest, not only those species and forms of mercury produced in a combustion source, most notably a combustion source fueled by coal, oil or other fossil fuels.

Further, gas streams other than flue gas streams of combustion sources can be analyzed using the system and method according to principles of the present invention. For example, other types of production flows and even naturally-occurring flows such as those used in the study of volcanology, for example, would benefit from the present invention.

What is claimed is:

1. A probe for obtaining a sample from a gas stream, comprising:
an outer housing having a first end for a gas inlet and a second end;
at least one hollow channel within the housing;
a sample insert removably received within the hollow channel having a first end with a gas inlet and a second end for connection to downstream processing equipment;
at least one heating cable in heating communication with the sample insert; and
a thermal insulator disposed within the outer housing and surrounding the sample insert and the heating cable.

2. The probe according to claim 1 further comprising a first thermocouple in heat sensing communication with the probe and having output conductors associated with the probe.

3. The probe according to claim 1 further comprising a second thermocouple in heat sensing communication with the sample insert and having output conductors associated with the probe.

4. The probe according to claim 1 further comprising a shell surrounding the sample insert.

5. The probe according to claim 4 wherein the sample insert is removably inserted within the shell.

6. The probe according to claim 5 wherein the shell is removably inserted within the housing.

7. The probe according to claim 4 wherein the shell is removably inserted within the housing.

8. The probe according to claim 1 wherein the housing defines a second hollow channel receiving another sample insert.

9. The probe according to claim 8 wherein sample inserts are spaced apart, one from the other.

10. The probe according to claim 1 further comprising a shell surrounding the sample insert, having a first end releasably joined to the housing with a compression fitting.

11. The probe according to claim 10 wherein the first end of the sample insert protrudes beyond the compression fitting.

12. The probe according to claim 10 wherein the second end of the sample insert protrudes beyond the second end of the housing.

13. A cartridge for removable positioning within a probe to obtain a sample from a gas stream, comprising:
an outer shell having a first end for a gas inlet and a second end;
at least one hollow channel within the shell;
a sample insert removably received within the hollow channel having a first end with a gas inlet and a second end for connection to downstream processing equipment;
the first end of the shell having a releasable engagement for releasably engaging the probe; and
at least one gas seal between the sample insert and the shell.

14. The cartridge of claim 13 wherein the releasable engagement comprises a ferrule secured about the first end of the shell.

15. The cartridge of claim 13 wherein the gas seal comprises an o-ring disposed between the sample insert and the shell.

16. The cartridge of claim 13 wherein the gas seal comprises a plurality of o-rings disposed between the sample insert and the shell.

17. The cartridge of claim 13 wherein the gas seal comprises at least three o-rings, two disposed between the sample insert and the shell adjacent the second end of the shell, and one o-ring disposed between the sample insert and the shell adjacent the first end of the shell.

18. The cartridge of claim 13 wherein the sample insert comprises a hollow tube with a first end extending beyond the first end of the shell and a second end extending beyond the second end of the shell.

19. The cartridge of claim 13 wherein the sample insert comprises a hollow tube containing sorbent trap material.

20. A method of obtaining a sample from a gas stream, comprising:
providing an outer housing having a first end for a gas inlet and a second end;
providing the housing with at least one hollow channel;
providing a shell with a first end for a gas inlet and a second end;
removably inserting the shell within the hollow channel, with the first ends of the housing and the shell adjacent one another, and with the second ends of the housing and the shell adjacent one another;
providing a sample insert with a first end having a gas inlet and a second end having gas outlet;
removably inserting the sample insert within the shell with the first ends of the housing, the shell and the sample insert adjacent one another, and with the second ends of the housing, the shell and the sample insert adjacent one another; and
removably securing at least one of the shell and sample insert to the housing.

21. The method of claim 20 wherein the housing is provided with a threaded member for receiving the shell and the sample insert and a fitting is provided for the shell and the step of removably securing comprises engaging the housing with the fitting.

22. The method of claim 21 wherein the shell and the sample insert are removed from the housing upon disengagement of the fitting and the housing.

23. The method of claim 21 wherein the sample insert is removed from the shell upon disengagement of the fitting and the housing.

24. The method of claim 20 further comprising the step of providing a at least one heating cable in heating communication with the sample insert.

25. The method of claim 20 further comprising the step of providing at least one thermal sensor in heat sensing communication with the sample insert.
